(19) United States
(12) Patent Application Publication
(10) Pub. No.: US 2013/0318310 A1
(43) Pub. Date: Nov. 28, 2013

(54) PROCESSOR PROCESSING METHOD AND PROCESSOR SYSTEM

(71) Applicant: FUJITSU LIMITED, Kawasaki-shi (JP)

(72) Inventors: Hiromasa Yamauchi, Kawasaki (JP); Koichiro Yamashita, Hachioji (JP); Takahisa Suzuki, Kawasaki (JP); Koji Kurihara, Kawasaki (JP); Fumihiko Hayakawa, Kawasaki (JP); Toshiya Otomo, Kawasaki (JP)

(73) Assignee: FUJITSU LIMITED, Kawasaki-shi (JP)

(21) Appl. No.: 13/949,922

(22) Filed: Jul. 24, 2013

Related U.S. Application Data
(63) Continuation of application No. PCT/JP2011/051353, filed on Jan. 25, 2011.

(51) Int. Cl. G06F 12/00

(52) U.S. Cl. CPC G06F 12/00
USPC 711/151

(57) ABSTRACT

A processor processing method is executed by a memory controller, and includes determining based on a log of access of a shared resource by a first application, whether the first application running on a first processor operates normally; and causing a second processor to run a second application other than the first application upon the first application being determined to not be operating normally.

### CROSS REFERENCE TO RELATED APPLICATIONS

This application is a continuation application of International Application PCT/JP2011/051353, filed on Jan. 25, 2011 and designating the U.S., the entire contents of which are incorporated herein by reference.

### FIELD

The embodiments discussed herein are related to a processor processing method and a processor system that control access of a shared resource.

### BACKGROUND

Conventionally, memory architectures of multi-core processor systems include two types, i.e. a shared memory architecture and a distributed memory architecture. In the shared memory architecture, a main memory is shared by plural central processing units (CPUs) of the multi-core processor. In the distributed memory architecture, each of the CPUs of the multi-core processor is provided with a main memory. Mainly employed in an assembly system is the shared memory architecture that can be equipped at low cost.

In the shared memory architecture when requests for access of the memory conflict by two CPUs conflict while the two CPUs run respective applications, one CPU waits for access of the memory and the other CPU accesses the memory. If the latter CPU makes an enormous number of memory accesses, the former CPU must continue to stand by. Thus, a technique is known that limits memory access when a predetermined count is exceeded (see, for example, Japanese Laid-Open Patent Publication Nos. H9-282252 and 2004-133496).

When a failure occurring as a result of an application running on a CPU brings about an unlimited number of accesses to the shared memory, the access of the shared memory may be performed endlessly if a bug occurs as consequent to running the application on the CPU. Thus, a technique (Prior Art 1) is known in which each CPU determines whether a failure occurs in the running of an application based on the run time of the application assigned to the each CPU (see, for example, Japanese Laid-Open Patent Publication No. 2006-202076).

Another technique (Prior Art 2) is known in which in the shared memory architecture, a bus mediating circuit to which plural CPUs are connected identifies a CPU in an error state based on a signal sent from each of the CPUs (see, for example, Japanese Laid-Open Patent Publication Nos. 2004-171072 and H6-124248).

In the prior art 1, however, there is a problem that, if the run time of an application is prolonged consequent to the CPU to which an application is assigned being in an error state, all applications newly assigned to the CPU also result in error. When plural applications are assigned to the CPU, the respective run times become longer.

Although the prior art 2 can identify a CPU in an error state by the bus mediating circuit, a problem arises in that error results together with the error of the application assigned to the CPU.

### SUMMARY

According to an aspect of an embodiment, a processor processing method is executed by a memory controller, and includes determining based on a log of access of a shared resource by a first application, whether the first application running on a first processor operates normally; and causing a second processor to run a second application other than the first application upon the first application being determined to not be operating normally.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view of one example of the embodiments;

FIG. 2 is an explanatory view of another example of the embodiments;

FIG. 3 is an explanatory view of one example of access tendency;

FIG. 4 is an explanatory view of another example of access tendency;

FIG. 5 is a block diagram of hardware of a multi-core processor system;

FIG. 6 is an explanatory view of an example of a management table;

FIG. 7 is an explanatory view of an example of load information;

FIG. 8 is a block diagram of a memory controller 509;

FIG. 9 is an explanatory view of an example of an access log related to an access count;

FIG. 10 is an explanatory view of an example of an access log 900 according to a first example;

FIG. 11 is an explanatory view of an example of migration of an app #2;

FIG. 12 is an explanatory view of an example of software resetting;

FIG. 13 is an explanatory view of an example of hardware resetting;

FIG. 14 is a flowchart of an updating procedure example of updating processes of the access log related to the access count;

FIGS. 15 and 16 are flowcharts of a control procedure of control processes by the memory controller 509 according to the first example;

FIGS. 17A and 17B are explanatory views of an example where the memory controller 509 lowers the ratio of access;

FIG. 18 is an explanatory view (1) of the access log 900 of a second example;

FIG. 19 is an explanatory view (2) of the access log 900 of the second example;

FIGS. 20 and 21 are flowcharts of a control procedure of control processes by the memory controller 509 according to the second example;

FIG. 22 is an explanatory view of an example of an access log related to a memory address;

FIG. 23 is an explanatory view of an access log 2200 of a third example;

FIG. 24 is a flowchart of an updating procedure example for updating the access log related to the memory address;

FIG. 25 is an explanatory view (1) of the access log of a fourth example; and

FIG. 26 is an explanatory view (2) of the access log of the fourth example.

### DESCRIPTION OF EMBODIMENTS

Preferred embodiments of a processing method and a processor system will be described in detail with reference to the accompanying drawings. The processor system is, for example, a multi-core processor system. In the multi-core processor system, a multi-core processor is a processor having plural cores. As long as plural cores are provided, the multi-core processor may be a single processor having plural cores or a group of single-core processors arranged in parallel. In this embodiment, for the simplification of description, a group of single-core processors arranged in parallel will be described as an example.

In this embodiment, a shared memory is an example of a shared resource that is shared by CPUs of the multi-core processor and a process will be described as an example in which a memory controller executes steps of the processor process method. If a CPU executes processor processing described in this embodiment and a failure occurs in the CPU, the failure cannot be detected. Thus, the processor processing of the present embodiment is performed by the memory controller that is a peripheral device to control access to the shared memory shared in the multi-core processor. Accordingly, even if a failure occurs at one of the CPUs of the multi-core processor, the failure can be detected. A failure of the memory controller can be detected by the CPUs making a request for access of the shared memory.

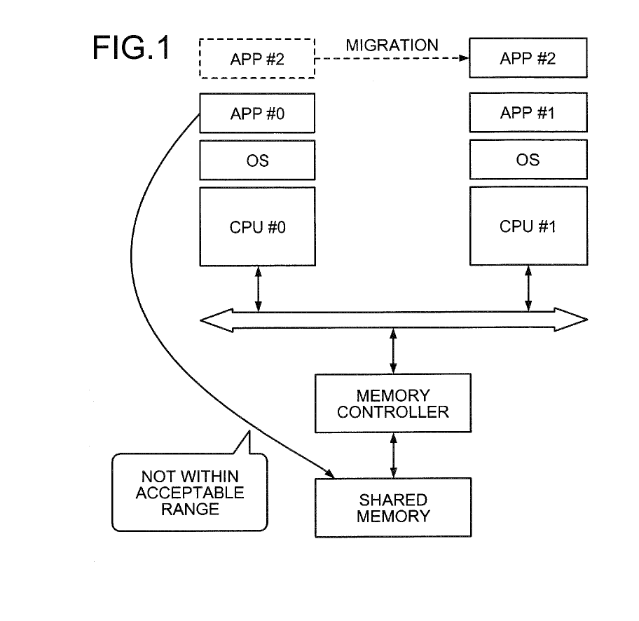

FIG. 1 is an explanatory view of one example of the embodiments. The memory controller determines whether tendency data is within an acceptable range. The tendency data indicates access of the shared memory shared by an app #0 under execution by a CPU #0, the shared memory being shared by the CPUs of the multi-core processor.

If the memory controller determines that the access tendency data is not within the acceptable range, the memory controller controls a migration process that causes another application (app #2) other than the app #0 already assigned to the CPU #0 to migrate from the CPU #0 to a CPU #1 that is another CPU of the multi-core processor.

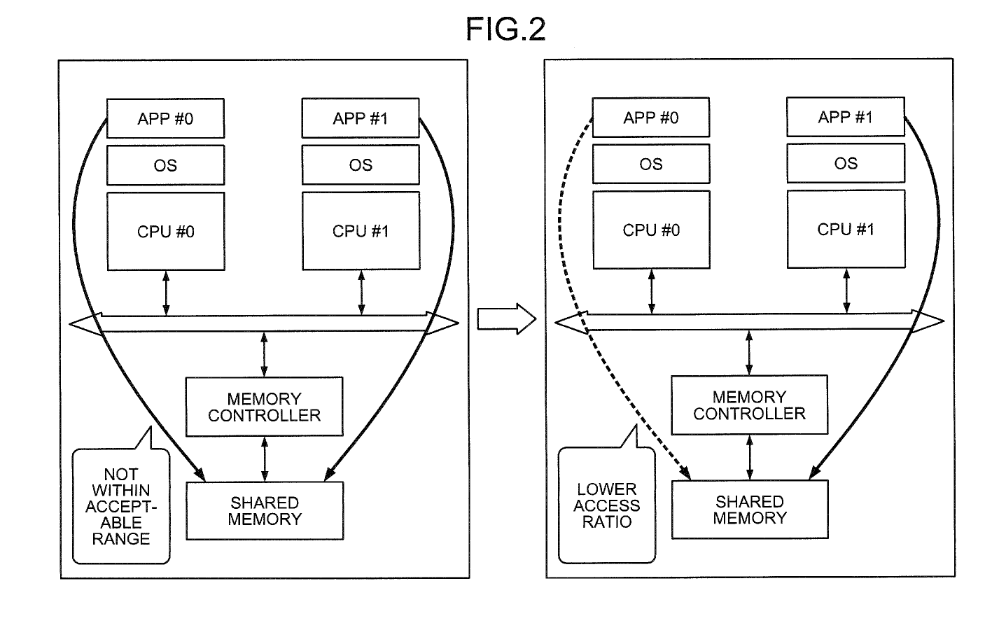

FIG. 2 is an explanatory view of another example of the embodiments. The memory controller determines whether the tendency data indicating access of the shared memory by the app #0 under execution by the CPU #0 is within an acceptable range. If the memory controller determines that the access tendency data is not within an acceptable range, the memory controller lowers the ratio of access of the shared memory by the app #0 to a value that is lower than that before the determination.

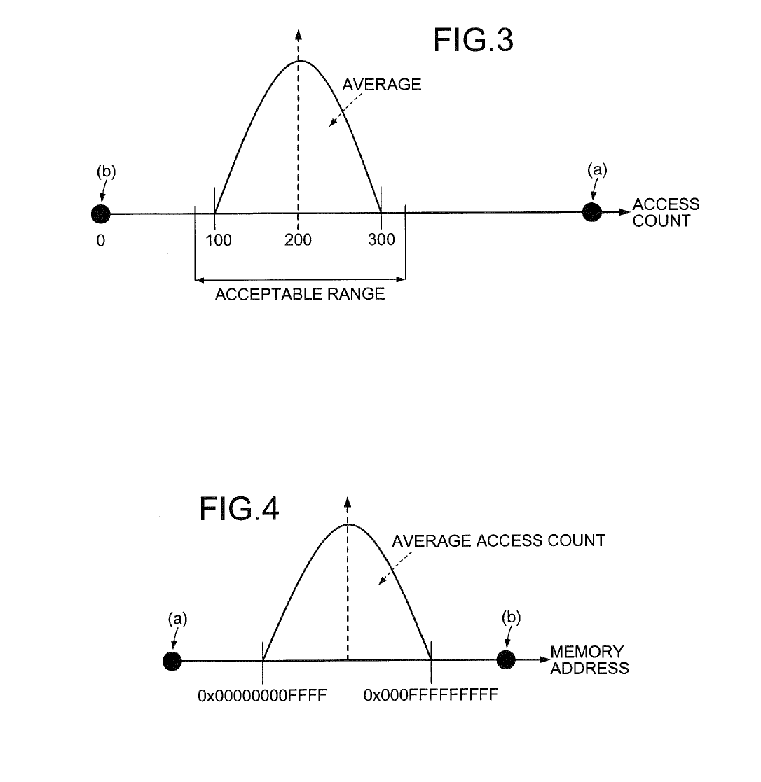

FIG. 3 is an explanatory view of one example of access tendency. FIG. 3 depicts access of the shared memory by an application during normal operation. For example, a browser application accesses the shared memory about 100,000 times per minute. The frequency of access differs for each application.

For example, an application is assumed to access the shared memory 100 to 300 times on the average during a predetermined period, under normal operation. However, if the application accesses the shared memory 500 times ((a) in FIG. 3) during the predetermined execution period, the application may possibly be in the error state.

If an application makes no access to the shared memory during the predetermined execution period (the access count is 0; (b) in FIG. 3), the application may possibly be in a hang-up state. For example, at the time of design, the designer defines the acceptable range of the access count as an average ±10%. In the present embodiment, the predetermined time is, for example, a time from one timer interruption up to the next timer interruption.

FIG. 4 is an explanatory view of another example of access tendency. FIG. 4 depicts the tendency of access of memory addresses by an application during normal operation. A memory address is a logical address. FIG. 4 indicates that the memory addresses accessed by an application during normal operation ranges from 0X00000000FFFF to 0X000FFFFFFFFF.

For example, if, during the execution of an application, the application often accesses a memory address ((a) and (b) of FIG. 4) other than 0X00000000FFFF to 0X000FFFFFFFFF, the application may possibly read out an error code. Thus, the application may possibly be in the error state. The definition of an acceptable range of the memory address will be later.

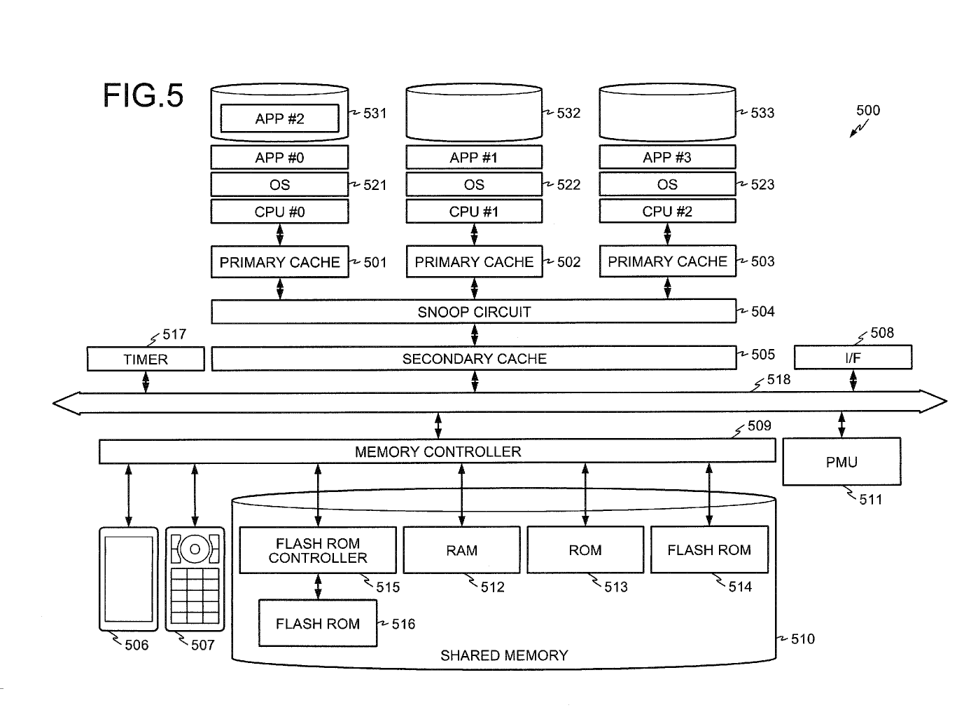

FIG. 5 is a block diagram of hardware of a multi-core processor system. A multi-core processor system 500 includes CPUs #0 to #2, primary caches 501 to 503, a snoop circuit 504, and a secondary cache 505. The multi-core processor system 500 further includes a display 506, a keyboard 507, an interface (I/F) 508, a memory controller 509, a shared memory 510, a PMU 511, and a timer 517.

The secondary cache 505, the I/F 508, the memory controller 509, and the PMU 511 are connected via a bus 518. The display 506, the keyboard 507, and the shared memory 510 are connected to the components by way of the memory controller 509.

The CPUs #0 to #2 each have a register and a core. The register includes a program counter (PC) and a reset register. The value of the reset register is normally 0 and, if set to 1, a reset process is performed for the CPU having the reset register. The CPU #0 is a master CPU that provides overall control of the multi-core processor system 500 and that runs an operating system (OS) 521.

The OS 521 is a master OS that controls to which CPU of the multi-core processor, applications are to be assigned. The OS 521 runs applications assigned to the CPU #0. The OS 521 has a scheduler that switches and executes the applications assigned to the CPU #0.

The CPU #1 is a slave CPU that runs an OS 522. The OS 522 is a slave OS that runs applications assigned to the CPU #1. The OS 522 has a scheduler that switches and executes the applications assigned to the CPU #1.

The CPU #2 is a slave CPU that runs an OS 523. The OS 523 is a slave OS that runs applications assigned to the CPU #2. The OS 523 has a scheduler that switches and executes the applications assigned to the CPU #2.

The OSs 521 to 523 have ready queues 531 to 533, respectively. The ready queues each have a pointer to context information of the applications that are assigned to the CPUs. Context information is for example information that includes the run state of a loaded application, variables in the application, etc. Each OS acquires the pointer of the context information in the ready queue to access the context information of the application so that the OS can immediately run the application.

In this example, the app #0 and #2 are assigned to the CPU #0, the app #0 is executed, and the pointer of the context information of the app #2 is embedded in the ready queue 531. An app #1 is assigned to the CPU #1 and is executed thereby. An app #3 is assigned to the CPU #2 and is executed thereby.

The CPU #0 is connected to the components via the primary cache 501, the snoop circuit 504, and the secondary cache 505. The CPU #1 is connected to the components via the primary cache 502, the snoop circuit 504, and the secondary cache 505. The CPU #2 is connected to the components via the primary cache 503, the snoop circuit 504, and the secondary cache 505. The primary caches 501 to 503 each have a cache memory and a cache controller.

The primary cache 501 temporarily stores writing to the shared memory 510 by the application executed by the OS 521. The primary cache 501 temporarily stores data read from the shared memory 510. The primary cache 502 temporarily stores writing to the shared memory 510 from the application executed by the OS 522. The primary cache 502 temporarily stores data read from the shared memory 510. The primary cache 503 temporarily stores writing to the shared memory 510 from the application executed by the OS 523. The primary cache 503 temporarily stores data read from the shared memory 510.

When data shared by the primary caches 501 to 503 is updated in one of the primary caches, the snoop circuit 504 detects the updating and updates the data concerning the other primary caches as well.

The secondary cache 505 has a cache memory and a cache controller. The secondary cache 505 stores data expelled from the primary cache 501 or 502. The secondary cache 505 stores data shared by the OSs 521 and 522. The secondary cache 505 has a larger storage capacity and a lower access speed from the CPU as compared to the primary caches 501 and 502. The secondary cache 505 has a smaller storage capacity and a higher access speed from the CPU as compared to the shared memory 510.

The display 506 displays, for example, data such as text, images, functional information, etc., in addition to a cursor, icons, and/or tool boxes. The display 506 may be a touch panel having keys for entering numerals, various instructions, etc. and may be used for data input. A thin-film-transistor (TFT) liquid crystal display and the like may be employed as the display 211.

The keyboard 507 has keys for entering numerals, various instructions, etc. and is used for data input. Further the keyboard 507 may be a touch panel type input pad, a numeric keypad, etc.

The I/F 508 is connected to a network such as a local area network (LAN), a wide area network (WAN), and the Internet through a communication line and is connected to other apparatuses through the network. The I/F 508 administers an internal interface with the network and controls the input and output of data with respect to external apparatuses. For example, a modem or a LAN adaptor may be employed as the I/F 508.

The PMU 511 supplies power-supply voltage to the components. For example, the PMU 511 has a function of, when receiving CPU identification information from the CPUs or the memory controller 509, turning off power to the CPU indicated by the identification information based on the received CPU identification information and thereafter again turning on the power. This allows hardware resetting of the CPU. The timer 517 counts the time and interrupts the memory controller 509 at given intervals (timer interruption).

The shared memory 510 is memory shared by the CPUs #0 to #2 and includes for example random access memory (RAM) 512, read only memory (ROM) 513, flash ROM 514, a flash ROM controller 515, and flash ROM 516.

The ROM 513 stores programs such as a boot-loader describing a boot sequence. The RAM 512 is used as a work area of the CPUs. The flash ROM 514 stores system software and applications of the OSs 521 and 522, as well as management tables and load information described hereinafter. For example, when the OSs are updated, the multi-core processor system 500 received the new OS via the I/F 508 and updates with the new OS received, the old OS stored in the flash ROM 514.

The flash ROM controller 515, under the control of the CPUs, controls the reading and the writing of data with respect to the flash ROM 516. The flash ROM 516 stores the data written thereto under the control of the flash ROM controller 515. An example of the data is image data, moving picture data, etc. acquired by the user of the multi-core processor system 500, via the I/F 508. A memory card, SD card, etc. may be adopted as the flash ROM 516, for example.

The bus 518 has a bus mediating circuit not depicted that has a function of mediating access from the components.

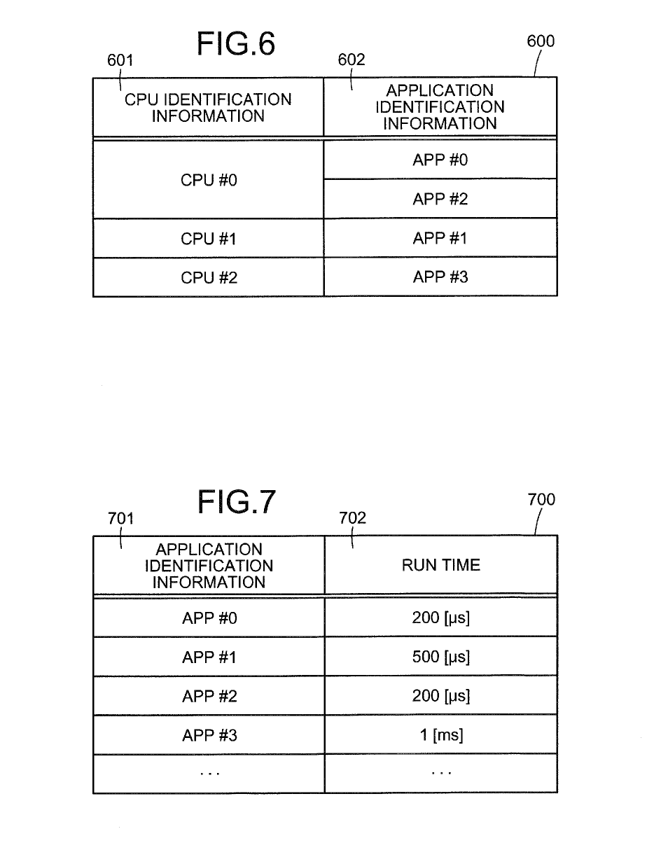

FIG. 6 is an explanatory view of an example of a management table. The management table 600 is a chart indicating application assignment with respect to the CPUs. The management table 600 has a CPU identification information field 601 and an application identification information field 602. CPU identification information is entered into the CPU identification information field 601. The application identification information field 602 indicates identification information of an application that is assigned to the CPU indicated by the identification information indicated in the CPU identification information field 601.

The management table 600 is updated by the master CPU when the master CPU assigns an application to one of the CPUs. The management table 600 is updated by the CPUs when a CPU migrates an application to another CPU. The management table 600 is updated by the CPUs when a CPU ends an assigned application. The management table 600 is stored in a storage device such as the shared memory 510, the primary cache and the secondary cache 505 of each CPU.

FIG. 7 is an explanatory view of an example of load information. The load information 700 has an application identification information field 701 and a run time field 702. Application identification information is entered in the application identification information field 701. The run time field 702 indicates the run time of the application indicated by identification information indicated in the application identification information field 701.

For example, the memory controller 509 calculates for each CPU, the total run time of applications assigned to the each CPU based on the load information 700, and identifies the CPU having the lowest total value as being the CPU with the minimum load. The load information 700 is stored in a storage device such as the shared memory 510, the primary cache of each CPU, and the secondary cache 505.

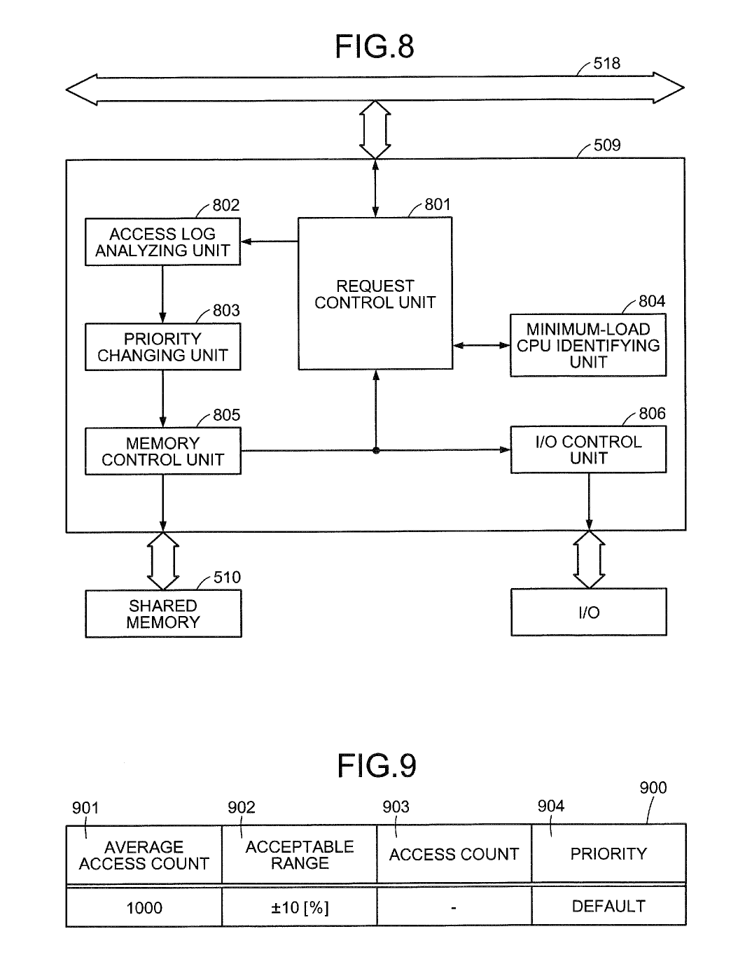

Reference of the description returns to FIG. 5. The memory controller 509 mediates access of the shared memory by the CPUs #0 and #1, for example. Details of the memory controller 509 will be described with reference to FIG. 8.

FIG. 8 is a block diagram of the memory controller 509. The memory controller 509 includes a request control unit 801, an access log analyzing unit 802, a priority changing unit 803, a minimum-load CPU identifying unit 804, a memory control unit 805, and an input/output (I/O) control unit 806. The request control unit 801 to the I/O control unit 806 can be implemented by using logical circuits or flip flops (FFs).

The memory controller 509 may have a CPU or a storage device such that the storage device in the memory controller 509 stores a program implementing the processes of the request control unit 801 to the I/O control unit 806. The CPU in the memory controller 509 may read the program to execute the processes coded in the program. The program may be recorded in a record medium such as the flash ROM 516 that is readable by one of the CPUs of the multi-core processor, whereby the program can be read from the record medium and executed by the one of the CPUs of the multi-core processor. The program may be distributed via a network such as Internet.

The request control unit 801 receives a memory access request from the CPUs of the multi-core processor. The request control unit 801 notifies the CPUs of data read from the shared memory 510.

The access log analyzing unit 802 determines whether the first application being executed by the first CPU is operating normally, based on the access log of the first application. The minimum-load CPU identifying unit 804 identifies the CPU having the minimum load from among the CPUs of the multi-core processor.

If a given application is not normally operating, the priority changing unit 803 lowers the priority of the access of the shared memory 510 by the given application, to a priority that is lower than that before the determination. If the current timer interruption determines that the given application was not operating normally at the previous timer interruption, but is currently operating normally, the priority changing unit raises the priority of the access to a priority that is higher than before the determination.

The memory control unit 805 writes data to the shared memory 510 according to the memory access request received from the CPUs. The memory control unit 805 reads data from the shared memory 510 according to the memory access request received from the CPUs.

The I/O control unit 806 controls the output to an I/O device such as the display 506 and the keyboard 507 and the input from the I/O device. For example, the I/O control unit 506 controls which CPU is to be notified of data input from the keyboard 507.

The access of the shared memory 510 by the memory controller 509 is publicly known (see, e.g., Japanese Laid-Open Patent Publication No. 2005-276237) and therefore the description thereof will be omitted.

Detailed processes will be described using first to forth examples. In the first and second examples, a case will be described where the access tendency data is the count of access to the shared memory 510. In the third and fourth examples, a case will be described where the access tendency data is information concerning the memory address of the shared memory 510.

In the first to fourth examples, the access log is analyzed for each of applications already assigned to the CPUs each time a timer interruption by the timer 517 is detected. The access log is reset after the termination of the analysis.

In the first example, the memory controller 509 determines whether the tendency data concerning access of the shared memory 510 by a given application under execution by one of the CPUs of the multi-core processor, is within the acceptable range. In the first example, if the access tendency data is determined as not being within the acceptable range, a migration process is controlled that causes another given application other than the given application already assigned to one of the CPUs to migrate from the CPU to another CPU of the multi-core processor. The access tendency data is stored as the access log for each application in a storage device such as the shared memory 510, the primary cache and the secondary cache 505 of the CPUs.

For the migration process, the memory controller 509 notifies one of the CPUs of a migration instruction to migrate the given application from the CPU to another given CPU. The CPU causes the application to migrate to the given CPU. Alternatively, for the migration process, the memory controller 509 notifies the given CPU of a migration instruction to migrate the given application from the CPU to the given CPU. The given CPU causes the application to migrate from the CPU to the given CPU.

In the migration process, the memory controller 509 sends to the CPU, a response confirmation and if no response is received from the CPU within a predetermined time after the sending of the response confirmation, the memory controller 509 sends to another given CPU, an instruction to migrate a given application from the CPU to the given CPU. The given CPU causes the application to migrate from the CPU to the given CPU.

If no response is received from the CPU, the CPU may not be operating consequent to an error state. Since the CPU may not be able to execute the migration process, the memory controller 509 causes the given CPU to execute the migration process. If a response is received from the CPU, the memory controller 509 may cause either the CPU or the given CPU to execute the migration process. In the following detailed example, if a response is received from the CPU, the memory controller 509 causes the CPU to execute the migration process.

FIG. 9 is an explanatory view of an example of the access log related to the access count. FIG. 9 depicts an example of an access log 900 related to the access count of the app #0. The access log 900 has an average access count field 901, an acceptable range field 902, an access count field 903, and a priority field 904.

The average access count field 901 indicates the average count of access of the shared memory 510 per predetermined time by the app #0 under normal operation. The predetermined time is a time from the termination of the analysis until the occurrence of the next timer interruption. The average access count can be identified for example through verification using an electronic system level (ESL) verifying tool at the time of design of the app #0. In FIG. 9, a count of 1000 is indicated.

The acceptable range field 902 indicates the range in which the count of access from the app #0 to the shared memory 510 can be determined be normal based on the average access count indicated in the average access count field 901. In FIG. 9, ±10 [%] is indicated. Since the average total access count per predetermined time is 1000, the acceptable range is a count of 900 to 1100.

The access count field 903 indicates the access count related to app #0 for the current run during the predetermined time. The access count is counted by the CPU #0 to which the app #0 is assigned. The priority field 904 indicates the priority of the access of the shared memory 510 by the app #0. Either DEFAULT or LOW is entered in the priority field 904. LOW indicates a lower access ratio than DEFAULT. The DEFAULT access ratio and the LOW access ratio may be determined for each application or may be the same value.

Upon detecting a timer interruption, the memory controller 509 selects unanalyzed application from among applications assigned to the CPUs. In this example, the app #0 assigned to the CPU #0 is selected.

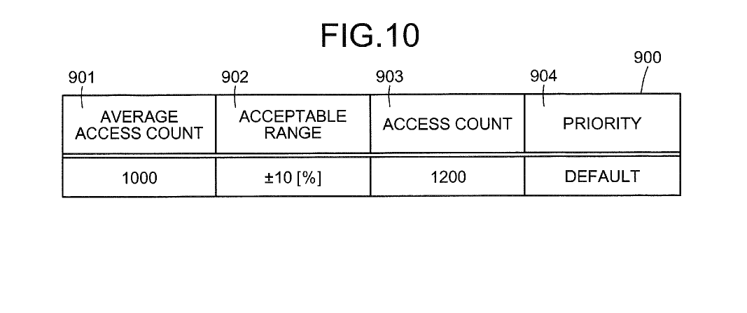

FIG. 10 is an explanatory view of an example of the access log 900 according to the first example. The memory controller 509, via the access log analyzing unit 802, refers to the access log 900 related to the app #0 and determines whether the access count of the app #0 is within the acceptable range. The value entered in the access count field 903 of the access log 900 is 1200. The acceptable range is 900 to 1000.

Thus, the access count of the app #0 is determined as not being within the acceptable range. By the request control unit 801, the memory controller 509 identifies a CPU to which the app is assigned and sends a response signal to the CPU and determines whether a response from the CPU is received in a given time. In this example, the CPU #0 is the CPU to which the app #0 is assigned and the memory controller 509 sends a response signal to the CPU #0.

If a response signal from the CPU #0 to the memory controller 509 is received within a predetermined time after the sending of a response signal, the app #0 or the OS 521 may be in the error state though the CPU #0 is in the operable state. If no response signal from the CPU #0 to the memory controller 509 is received within the predetermined time after the sending of the response signal, the CPU #0 may be in the inoperable error state. Here, separate descriptions will be given for a case in which a response signal from the CPU #0 is received by the memory controller 509 and a case in which no response signal is received.

If the memory controller 509 receives a response signal from the CPU #0 within a predetermined time after the sending of a response signal, the minimum-load CPU identifying unit 804 identifies the CPU having the minimum load among CPU #1 and the CPU #2 of the multi-core processor, exclusive of the CPU #0. For example, the memory controller 509 calculates the total run time of the applications assigned to each CPU and identifies the CPU having the minimum total value as being the minimum-load CPU.

Since the total run time of the applications assigned to the CPU #1 is 200 [μs] and the total run time of the applications assigned to the CPU #2 is 1 [ms], the CPU #1 is identified as being the minimum-load CPU. Although the memory controller 509 identifies the minimum-load CPU, the CPU #0 may identify the minimum-load CPU.

Via the request control unit 801, the memory controller 509 sends to the CPU #0, an interrupt signal that delivers an execution right to the OS 521. The memory controller 509 notifies the CPU #0 of a migration instruction to migrate from the CPU #0 to the CPU #1, all applications except the app #0 among the assigned applications. In this example, the app #2 is subject to migration.

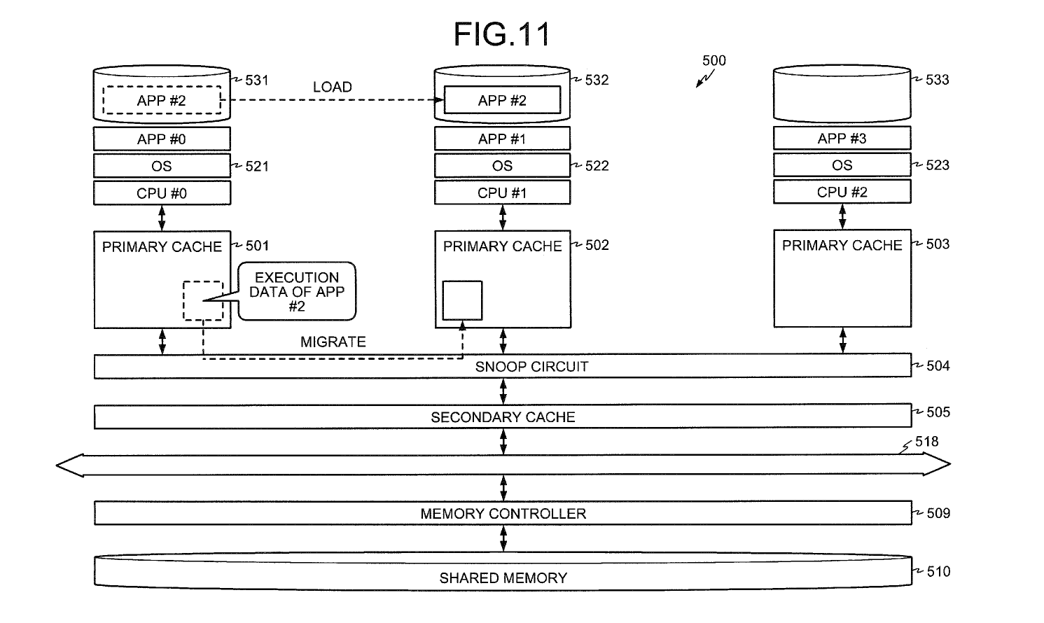

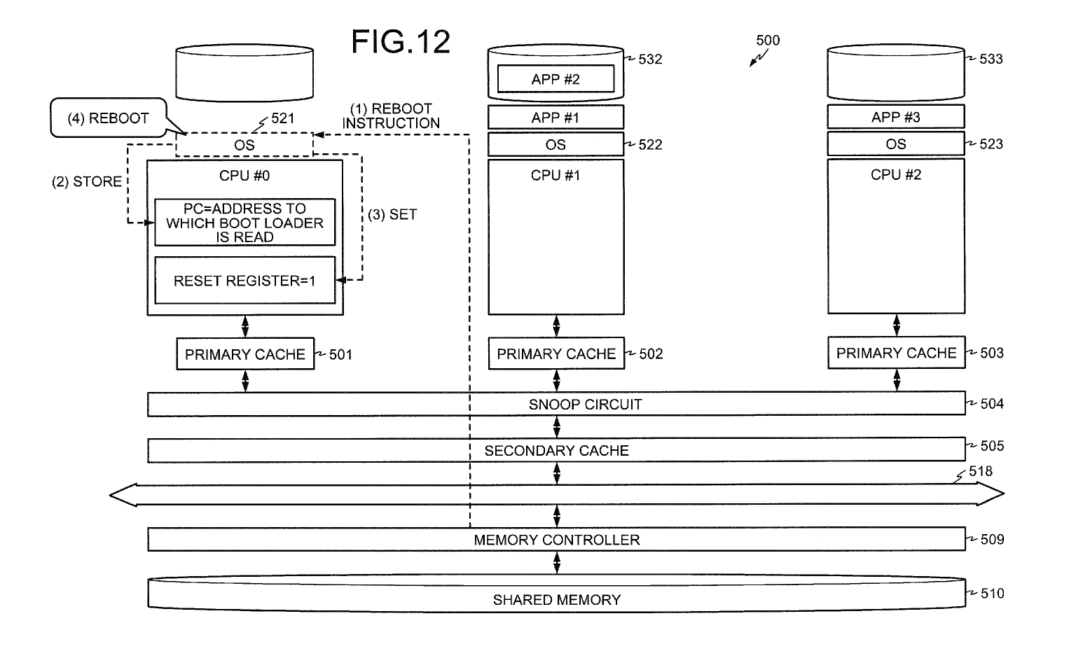

FIG. 11 is an explanatory view of an example of the migration of the app #2. Upon receiving the migration instruction, the OS 521 causes the execution data of the app #2 stored in the primary cache 501 to migrate to the primary cache 502, using the snoop circuit 504. The OS 521 embeds a pointer of the context information of the app #2 into the ready queue 532 of the CPU #1, ending the migration. The OS 521 notifies the memory controller 509 of the end of the migration. Upon receiving notification of the end of the migration, the memory controller 509, via the request control unit 801, controls a reset process to reset the software of the CPU #0. The memory controller 509 clears the value of the access count field 903 in the access log 900 related to the app #0.

FIG. 12 is an explanatory view of an example of software resetting. As used herein, the software resetting refers to rebooting the OS running on the CPU. The memory controller 509 controls the resetting process for the software of the CPU #0 by (1) notifying the OS 521 of a reboot instruction for the CPU #0 to reboot the OS 521.

Upon receiving the reboot instruction, the OS 521 reads out from the ROM 513 of the shared memory 510, a boot loader describing a boot sequence and expands the boot loader on the RAM 512 of the shared memory 510 or the primary cache 501. The OS 521 (2) stores to the PC of the CPU #0, the address at which the boot loader is expanded on the RAM 512 or the primary cache 501. The OS 521 sets the value of the reset register of the CPU #0. Thus, the OS 521 is rebooted.

If no response signal is from the CPU #0 within a certain time after the sending of a response signal, the memory controller 509 identifies the CPU having the minimum load from among the CPUs #1 and #2, exclusive of the CPU #0. The minimum-load CPU identifying process is similar to the process depicted in the case of the presence of the response signal and thus, detailed description thereof will be omitted. The CPU #1 is regarded as the minimum-load CPU.

The memory controller 509 sends to the CPU #1, an interrupt signal that delivers an execution right to the OS 522. The memory controller 509 notifies the CPU #1 of a migration instruction to migrate from the CPU #0 to the CPU #1, all applications except the app #0 among the assigned applications. In this example, the app #2 is subject to migration.

Upon receiving the migration instruction, the OS 522 causes the execution data of the app #2 stored in the primary cache 501 to migrate to the primary cache 502, using the snoop circuit 504. The OS 522 embeds a pointer of the context information of the app #2 into the ready queue 532 of the CPU #1, ending the migration. The OS 522 notifies the memory controller 509 of the end of the migration.

When receiving notification of the end of the migration from the OS 522, the memory controller 509 performs the resetting of the hardware of the CPU #0. The memory controller 509 clears the value of the access count field 903 in the access log 900 related to the app #0.

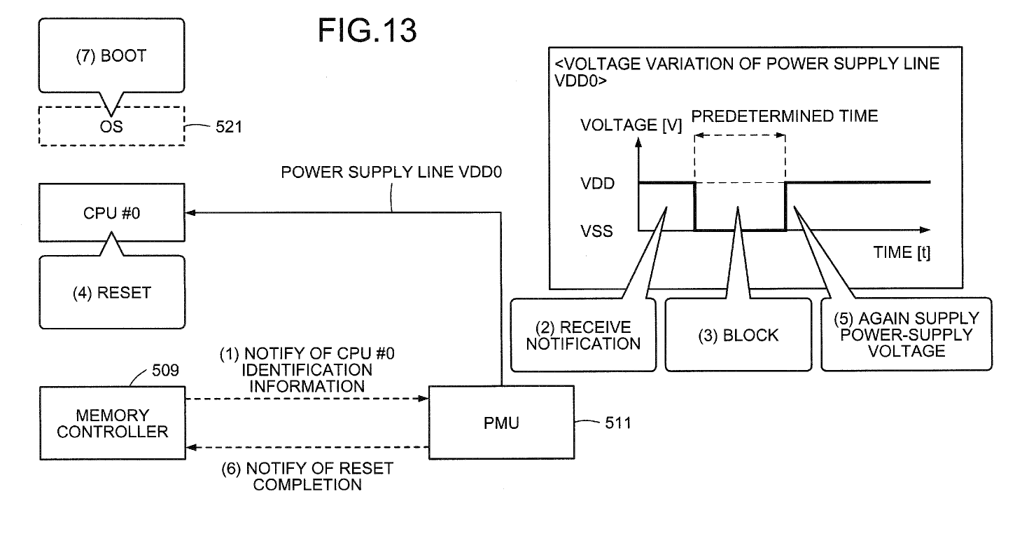

FIG. 13 is an explanatory view of an example of hardware resetting. As used herein, execution of the hardware resetting by the memory controller 509 refers to causing the PMU 511 to turn off the power supply to the CPU #0 and thereafter, again supply the power-supply voltage thereto. Detailed description will be given using a voltage variation of a power supply line VDD0 from the PMU 511 to the CPU #0. For example, the memory controller 509 (1) notifies the PMU 511 of identification information of the CPU #0. (2) Upon receiving the notification, the PMU 511 (3) turns off for a predetermined time, the power supply to the CPU #0 indicated by the identification information. The predetermined time refers to a defined time that allows the internal state of the CPU #0 to be reset.

By turning off the power supply for the predetermined time, the CPU #0 (4) resets the primary cache 501 or the setting of the register. Subsequently, the PMU 511 (5) again supplies the power-supply voltage and (6) notifies the memory controller 509 of the completion of the resetting. When the power supply to the CPU #0 is resumed, the CPU #0 (7) boots the OS 521.

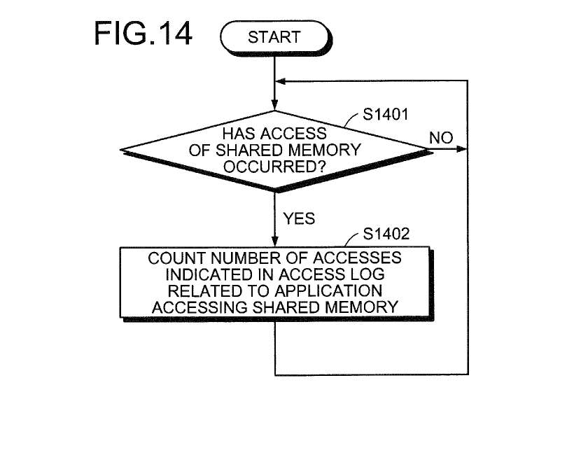

FIG. 14 is a flowchart of an updating procedure example of updating processes of the access log related to the access count. This updating procedure is performed for each OS. An OS determines whether access of the shared memory 510 has occurred (step S1401) and upon determining that no access of the shared memory 510 has occurred (step S1401: NO), returns to step S1401. Upon determining that access of the shared memory 510 has occurred (step S1401: YES), the OS counts the number of accesses indicated in the access log related to the application accessing the shared memory 510 (step S1402), and returns to step S1401.

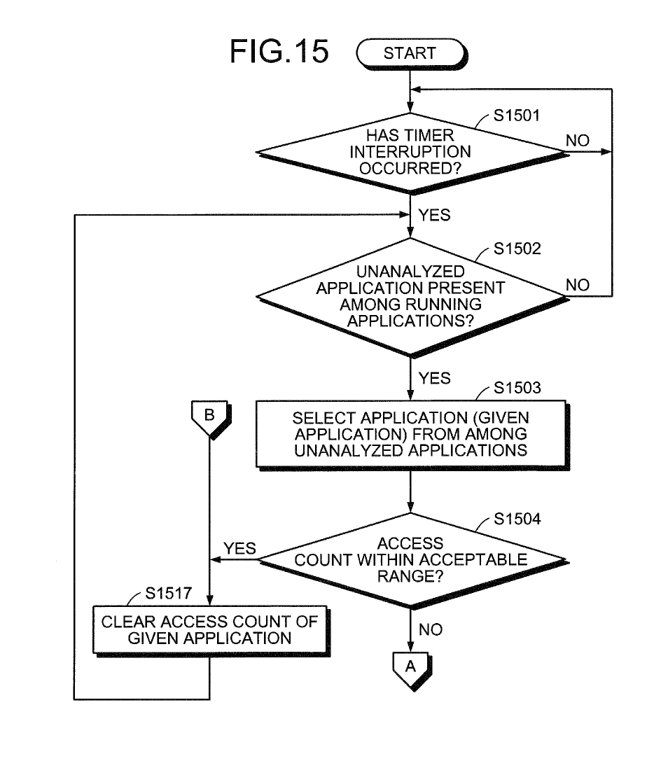

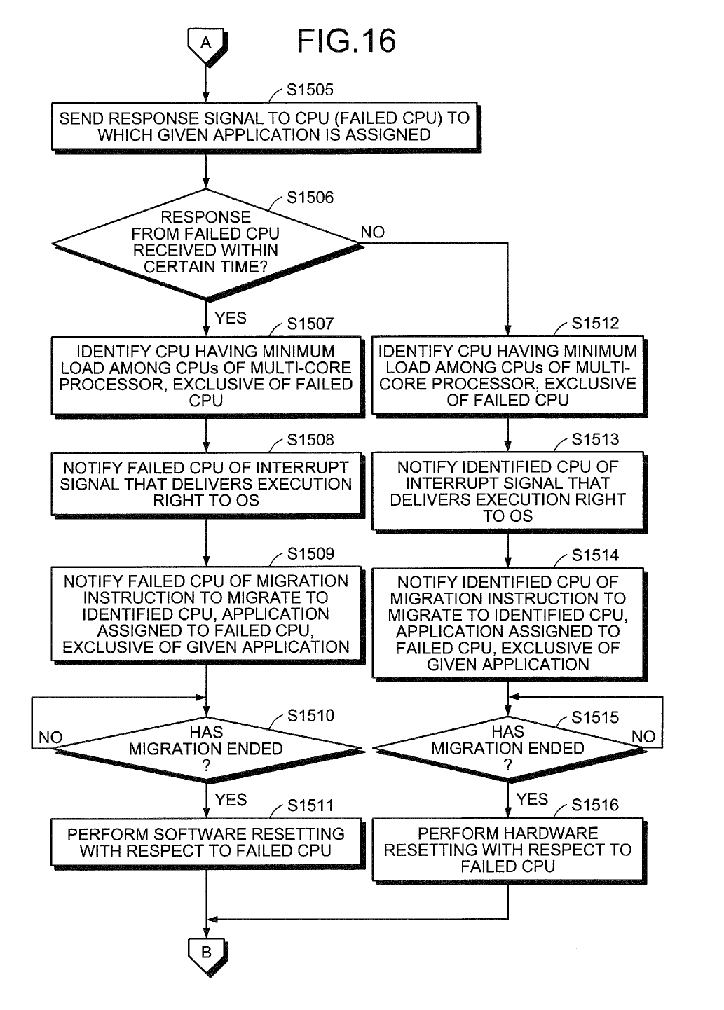

FIGS. 15 and 16 are flowcharts of a control procedure of control processes by the memory controller 509 according to the first example. The memory controller 509 first determines whether a timer interruption has occurred (step S1501). Upon determining that no timer interruption has occurred (step S1501: NO), the memory controller 509 returns to step S1501.

Upon determining that a timer interruption has occurred (step S1501: YES), the memory controller 509 determines whether an unanalyzed application is present among running applications (step S1502). Upon determining that an unanalyzed application is present (step S1502: YES), the memory controller 509 selects an application (a given application) from among the unanalyzed applications (step S1503).

The memory controller 509 then determines whether the access count is within the acceptable range (step S1504). Upon determining that the access count is within the acceptable range (step S1504: YES), the memory controller 509 goes to step S1517. Upon determining that the access count is not within the acceptable range (step S1504: NO), the memory controller 509 sends a response signal to the CPU (failed CPU) to which the given application is assigned (step S1505). The memory controller 509 determines whether a response from the failed CPU is received within a certain time (step S1506). Upon determining that a response from the failed CPU is received within a certain time (step S1506: YES), the memory controller 509 identifies the CPU having the minimum load among CPUs of the multi-core processor, exclusive of the failed CPU (step S1507).

The memory controller 509 notifies the failed CPU of an interrupt signal that delivers an execution right to the OS (step S1508) and notifies the failed CPU of a migration instruction to migrate from the failed CPU to the identified CPU, an application assigned to the failed CPU, exclusive of the given application (step S1509). The memory controller 509 determines whether the migration has ended (step S1510) and upon determining that the migration has not ended (step S1510: NO), returns to step S1510. Upon determining that the migration has ended (step S1510: YES), the memory controller 509 performs software resetting with respect to the failed CPU (step S1511) and goes to step 1517.

If at step S1506, no response from the failed CPU is received within a certain time (step S1506: NO), the memory controller 509 identifies the CPU having the minimum load among CPUs of the multi-core processor, exclusive of the failed CPU (step S1512). The memory controller 509 notifies the identified CPU of an interrupt signal that delivers an execution right to the OS (step S1513).

The memory controller 509 notifies the identified CPU of a migration instruction to migrate from the failed CPU to the identified CPU, an application assigned to the failed CPU, exclusive of the given application (step S1514). The memory controller 509 determines whether the migration has ended (step S1515) and upon determining that the migration has not ended (step S1515: NO), returns to step S1515. On the other hand, upon determining that the migration has ended (step S1515: YES), the memory controller 509 performs hardware resetting with respect to the failed CPU (step S1516) and goes to step S1517.

Subsequent to step S1511 or S1516, in the case of step S1504: YES, the memory controller 509 clears the access count of the given application from the access log related to the given application (step S1517) and returns to step S1502.

In the second example, the memory controller 509 determines whether the tendency data concerning access of the shared memory by a given application under execution by one of the CPUs of the multi-core process, is within an acceptable range. If the memory controller 509 determines the access tendency data as not being within the acceptable range, the memory controller 509 lowers to a value that is less than that before the determination, the ratio of access of the shared memory 510 by the given application.

The memory controller 509 further determines after the elapse of a predetermined time since the determination of whether the access count during a predetermined time is within an acceptable range. In other words, the memory controller 509 determines whether the access count is within the acceptable range. Upon determining that the access count during a predetermined time is not within the acceptable range, the memory controller 509 causes applications other than the given application assigned to one of the CPUs to migrate from the CPU to another CPU. A detailed example will be described.

When detecting a timer interruption, the memory controller 509 selects an unanalyzed application from among applications assigned to the CPUs. In this example, the app #0 assigned to the CPU #0 is selected. The memory controller 509 refers to the access log 900 related to the app #0 and determines whether the access count of the app #0 is within the acceptable range.

Since the value of the access count field 903 in the access log 900 of FIG. 10 is 1200 and the acceptable range is 900 to 1100, the count of access of the shared memory 510 by the app #0 is determined as not being within the acceptable range. The memory controller 509 lowers the ratio of access of the shared memory 510 by the app #0 to a value that is lower than that before the determination.

Two examples will be given in which the ratio of access of the shared memory 510 by the app #0 is lowered. In one of the two examples, the memory controller 509 controls the access received from the app #0 to lower the ratio of access to the shared memory 510 without changing the access of the memory controller 509 by the app #0.

In the other example, a bus mediating circuit of the bus 518 lowers the ratio of access of the memory controller 509 by the app #0 such that the ratio of access of the shared memory 510 by the app #0 is lowered to a value that is lower than that before the determination. The memory controller 509 notifies the bus mediating circuit of a given CPU to which the app #0 is assigned.

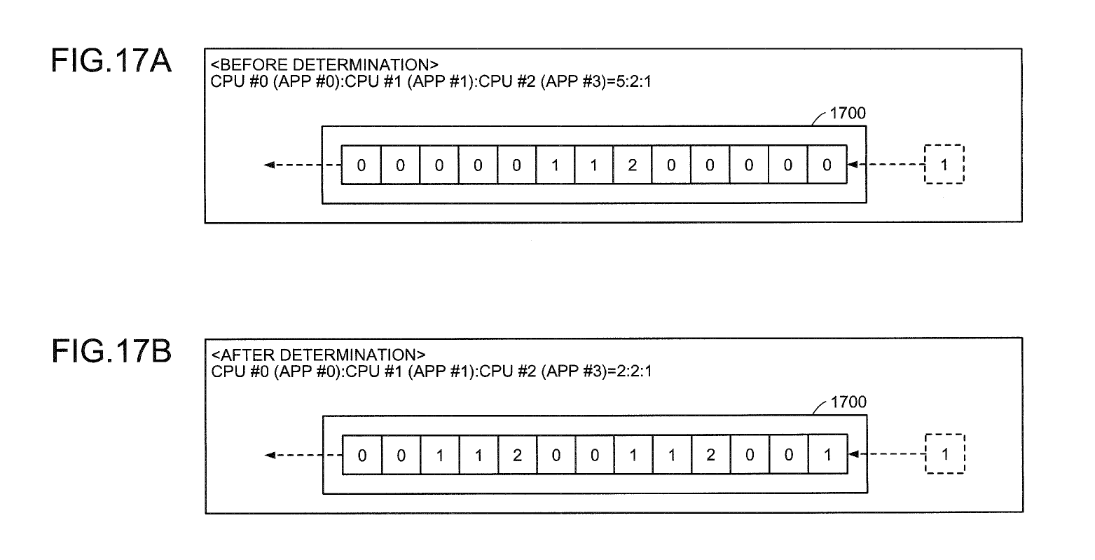

The bus mediating circuit lowers the frequency of access of the memory controller 509 by an outstanding buffer that buffers the access of the bus 518 by the given CPU. This enables the ratio of access of the shared memory 510 by the app #0 to be lowered to a value that is lower than before the determination. In the second example an example that will be described in detail with reference to FIGS. 17A and 17B is used.

FIGS. 17A and 17B are explanatory views of an example where the memory controller 509 lowers the ratio of access. The memory controller 509 controls access by the CPUs in the order of access requests entered in a request queue 1700. An example is assumed where the access ratios of the CPUs before the determination are as follows.

### CPU #0:CPU #1:CPU #2=5:2:1

Here, the access ratios of the CPUs OS are determined based on the running applications. Boxes in the request queue 1700 are access requests. The memory controller 509 receives the access request from right hand side of the request queue 1700 and processes the access request sequentially from left hand side. The memory controller 509 may have registers corresponding to the CPUs and enter the access ratios of the CPUs in the respective registers.

Among the boxes in the request queue 1700, a box with 0 is an access request from the CPU #0, a box with 1 is an access request from the CPU #1, and a box with 2 is an access request from the CPU #2.

In the request queue 1700 before the determination (FIG. 17A), five consecutive boxes with 0, two consecutive boxes with 1, a single box with 2, and again five consecutive boxes with 0 are depicted from the left hand side. Thus, the memory controller 509 sequentially makes five access requests for the CPU #0, two access requests for the CPU #1, and one access request for the CPU #2.

After the determination, the memory controller 509 lowers the access ratio of the CPU #0 running the app #0 to a value that is less than that before the determination. The amount by which the ratio is lowered is not limited. Here, the ratios after the lowering are assumed as follows.

### CPU #0:CPU #1:CPU #2=2:2:1

In the request queue 1700 after the determination (FIG. 17B), two consecutive boxes with 0, two consecutive boxes with 1, a single box with 2, and two consecutive boxes with 0 are depicted from the left hand side. Thus, the memory controller 509 sequentially makes two access requests for the CPU #0, two access requests for the CPU #1, and one access request for the CPU #2. In this embodiment, DEFAULT access ratios and LOW access ratios are determined.

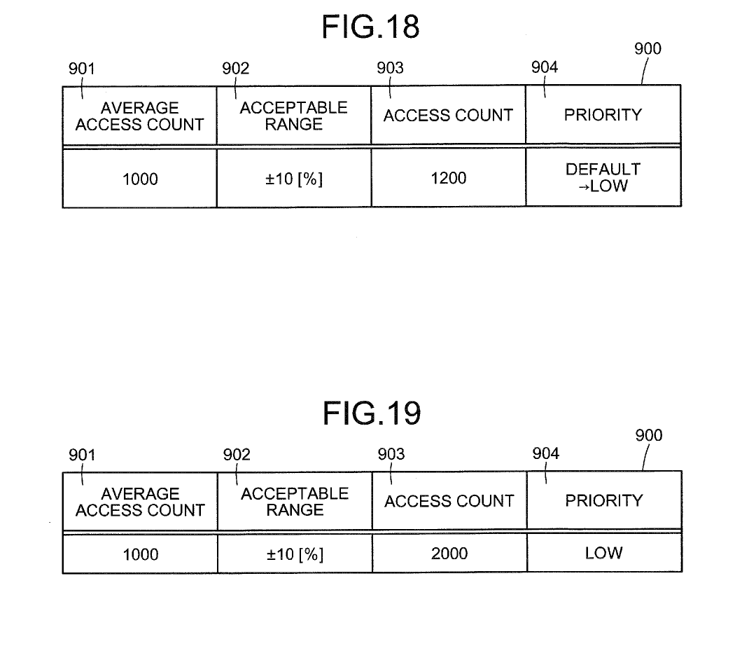

FIG. 18 is an explanatory view (1) of the access log 900 of the second example. The memory controller 509 changes the value of the priority field 904 in the access log 900 of the app #0 from DEFAULT to LOW. The memory controller 509 clears the value of the access count field 903 in the access log 900 related to the app #0. The memory controller 509 selects and analyzes an unanalyzed application among applications assigned applications, exclusive of the app #0.

When detecting the next timer interruption, the memory controller 509 selects any unanalyzed application from among the applications already assigned to the CPUs. In this example, the app #0 assigned to the CPU #0 is selected.

FIG. 19 is an explanatory view (2) of the access log 900 of the second example. The memory controller 509 refers to the access log 900 related to the app #0 and determines whether the access count of the app #0 is within the acceptable range. Since the value entered in the access count field 903 of the access log 900 is 2000 and the acceptable range is 900 to 1100, the access count of the app #0 is determined as not being within the acceptable range.

The memory controller 509 determines whether the access count of the app #0 continues to not be within the acceptable range. For example, the memory controller 509 checks whether the value of the priority field 904 in the access log 900 is LOW. Being LOW indicates that the access count is determined as not being within the acceptable range at the time of the previous timer interruption.

If the access count is not within the acceptable range consecutively at the previous timer interruption and at the current timer interruption, the app #0 or the CPU #0 to which the app #0 is assigned may have a high possibility of being in the error state. For example, if the access count is not within the acceptable range at the previous timer interruption but is within the acceptable range at the current timer interruption, the state of the app #0 or the CPU #0 may be unstable at the time of the previous timer interruption. It is however seen that the state of the app #0 or the CPU #0 is normal at the time of the current timer interruption.

In this case, the value of the priority field 904 in the access log 900 is already LOW and the state where the access count is not within the acceptable range continues. The memory controller 509 identifies the CPU to which the app #0 is assigned and sends a signal to the identified CPU to determine whether a response from the CPU is received within a given time. In this example, the CPU #0 is the assignment CPU of the app #0 and hence the memory controller 509 sends a response signal to the CPU #0.

When receiving a response signal from the CPU #0 within a certain time after the sending of a response signal, the memory controller 509 identifies the CPU having the minimum load among the CPUs #1 and #2 of the multi-core processor, exclusive of the CPU #0. For example, the memory controller 509 calculates for each of the CPUs, a total run time of applications assigned to the CPU and regards the CPU having the lowest total value as being a minimum-load CPU.

Since the total run time of applications assigned to the CPUs #1 and #2 are respectively 200 [μs] and 1 [ms], the CPU #1 is identified as being the minimum-load CPU. Although in this example, the memory controller 509 identifies a minimum-load CPU, the CPU #0 may identify the minimum-load CPU.

The memory controller 509 sends to the CPU #0, an interrupt signal that delivers an execution right to the OS 521 and notifies the CPU #0 of a migration instruction to migrate from the CPU #0 to the CPU #1, all applications among the assigned applications, excluding the app #0. In this example, the app #2 is subject to migration.

Upon receiving the migration instruction, the OS 521 causes execution data of the app #2 stored in the primary cache 501 to migrate from the primary cache 501 to the primary cache 502, using the snoop circuit 504. The OS 521 then embeds a pointer of the context information of the app #2 into the ready queue 532 to thereby end the migration. The OS 521 notifies the memory controller 509 of the end of the migration.

Upon receiving notification of the end of the migration, the memory controller 509 performs software resetting with respect to the CPU #0. The software resetting is the same as the example shown in the first example and thus, detailed description thereof will be omitted hereinafter. The memory controller 509 clears the value of the access count field 903 in the access log 900 related to the app #0 and changes the value of the priority field 904 from LOW to DEFAULT.

Since the processes described in the first example apply to a case (no response signal) where the memory controller 509 receives no response signal from the CPU #0 within a certain time after the sending of a response signal, detailed description of a case of no response signal in the second example will be omitted.

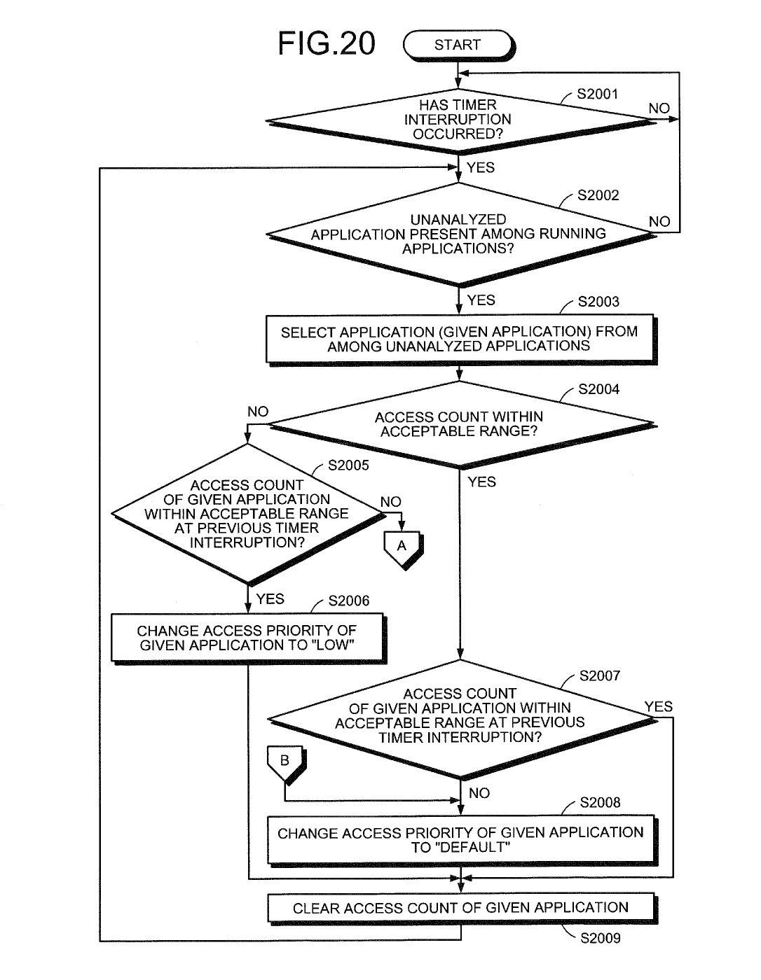

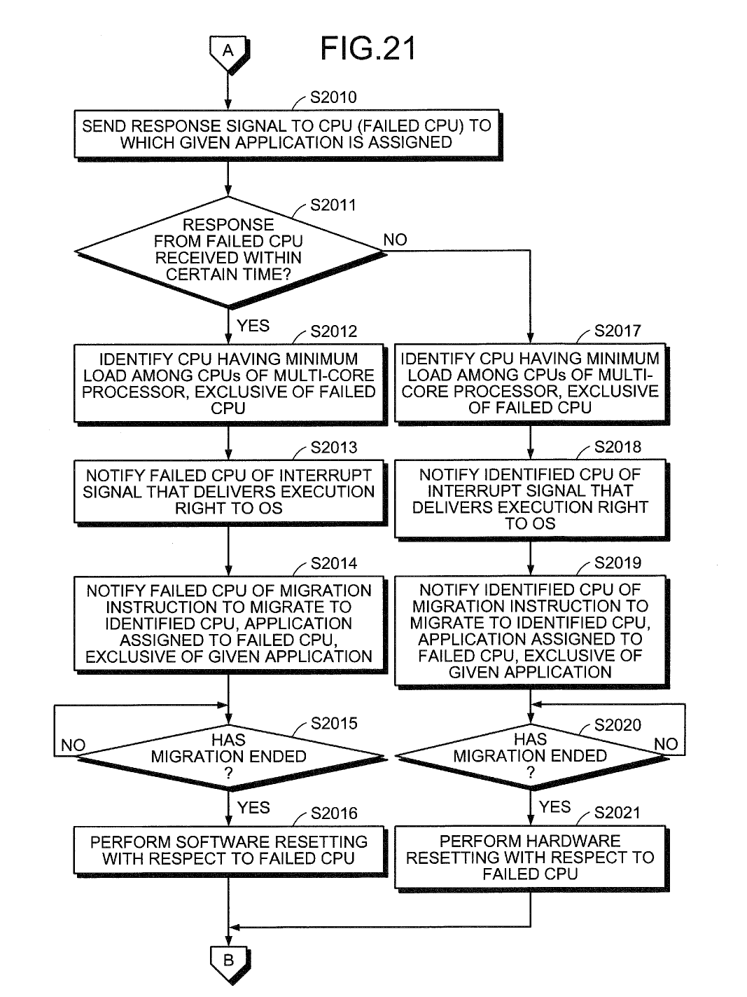

FIGS. 20 and 21 are flowcharts of a control procedure of control processes by the memory controller 509 according to the second example. Since steps S2001 to S2004 are the same processes as steps S1501 to 1504 and steps S2010 to S2021 are the same processes as steps S1505 to S1516, detailed description thereof will be omitted.

Subsequent to step S2004: NO, the memory controller 509 determines whether the access count of the given application is within the acceptable range at the time of the previous timer interruption (step S2005). Upon determining that the access count of the given application is in the acceptable range at the time of the previous timer interruption (step S2005: YES), the memory controller 509 changes the access priority of the given application to LOW (step S2006). Subsequent to step S2006, the memory controller 509 moves to step S2009. Upon determining that the access count of the given application is not within the acceptable range at the time of the last interruption (step S2005: NO), the memory controller 509 goes to step S2010.

Subsequent to the case of step S2004: YES, the memory controller 509 determines whether the access count of the given application is within the acceptable range at the time of the previous timer interruption (step S2007). Upon determining that the access count of the given application is not within the acceptable range at the time of the last interruption (step S2007: NO), the memory controller 509 changes the access priority of the given application to DEFAULT (step S2008). The memory controller 509 then clears the access count in the access log related to the given application (step S2009) and returns to step S2002.

Upon determining that the access count of the given application is in the acceptable range at the time of the last interruption (step S2007: YES), the memory controller 509 goes to step S2009.

In the third example, the details described in the first example will be described using the memory address instead of the access count.

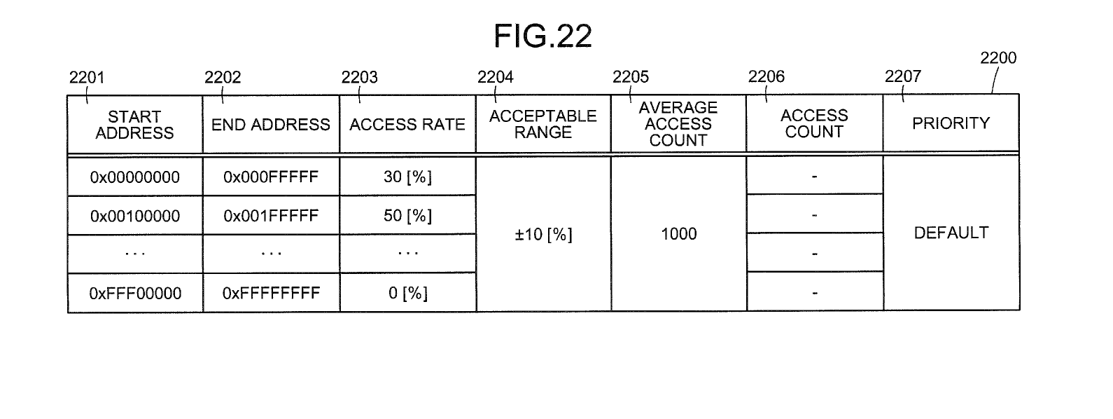

FIG. 22 is an explanatory view of an example of an access log related to the memory address. The access log 2200 related to the app #0 has a start address field 2201, an end address field 2202, and an access rate field 2203. The access log 2200 related to the app #0 further has an acceptable range field 2204, an average access count field 2205, an access count field 2206, and a priority field 2207.

The memory address is indicated in the start address field 2201 and the end address field 2202. The acceptable range is indicated in the acceptable range field 2204. The access rate field 2203 indicates the rate of access, by applications during the normal operation, to areas ranging from the memory address indicated in the start address field 2201 to the memory address indicated in the end address field 2202. The average access count field 2205 indicates the average count of access of the shared memory 510 by applications during normal access operation. The average access count is 1000.

For example, FIG. 22 shows that 30 [%] of the average access count is the access of 0X00000000 to 0X000FFFFF. In other words, 0X00000000 to 0X000FFFFF is accessed 300 (1000×30 [%]) times. Due to the acceptable range of ±10 [%], the acceptable range of the access count is represented as 270 to 330 and the acceptable range of the access rate is represented as 27 [%] to 33 [%].

The access count field 2206 indicates the number of times memory access is to the address ranges during the period from one timer interruption to the next timer interruption. The priority field 2207 indicates the priority of access of the shared memory 510 by the app #0. In this case, either DEFAULT or LOW is indicated in the priority field 2207. LOW indicates a lower access ratio than at DEFAULT.

When detecting a timer interruption, the memory controller 509 selects an unanalyzed application from among applications assigned to the CPUs. In this example, the app #0 assigned to the CPU #0 is selected.

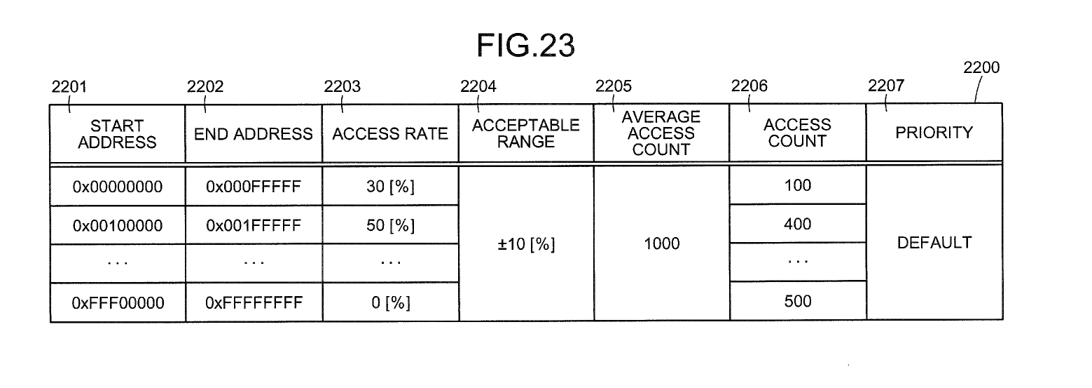

FIG. 23 is an explanatory view of the access log 2200 of the third example. In the access log 2200, the access count field 2206 is updated. 100 accesses are made to 0X00000000 to 0X000FFFFF. The rate of access to 0X00000000 to 0X000FFFFF is 10 (1000/100) [%].

400 accesses are made to 0X00100000 to 0X001FFFFF. The rate of access to 0x00100000 to 0X001FFFFF is 40 (1000/400) [%]. 500 accesses are made to 0XFFF00000 to 0XFFFFFFFF. The rate of access to 0XFFF00000 to 0XFFFFFFFF is 50 [%].

The memory controller 509 refers to the access log 2200 related to the app #0 and determines whether the rate of access to the memory addresses is within the acceptable range. Since, for example, the rate of access to 0XFFF00000 to 0XFFFFFFFF is 0 [%] and the rate of access at that timing interruption is 50 [%], the memory controller 509 determines the rate of access as not being within the predetermined range.

Thus, the access count of the app #0 is determined not to be within the acceptable range. The memory controller 509 identifies the CPU to which the app #0 is assigned and sends a signal to the CPU to determine whether a response from the identified assignment CPU is received within a given time. In this example, the CPU #0 is the CPU to which the app #0 is assigned and thus, the memory controller 509 sends a response signal to the CPU #0.

If receiving a response signal from the CPU #0 within a certain time after the sending of a response signal, the memory controller 509 identifies a minimum-load CPU from among the CPUs #1 and #2 of the multi-core processor, exclusive of the CPU #0. Although in this example the memory controller 509 identifies the minimum-load CPU, the CPU #0 may identify the minimum-load CPU.

The memory controller 509 sends to the CPU #0 an interrupt signal that delivers an execution right to the OS 521 and notifies the CPU #0 of a migration instruction to migrate from the CPU #0 to the CPU #1, all assigned apps, exclusive of the app #0. Here, the app #2 is subject to migration.

When receiving the migration instruction, the OS 521 causes execution data of the app #2 stored in the primary cache 501 to migrate from the primary cache 501 to the primary cache 502, using the snoop circuit 504. The OS 521 embeds a pointer of the context information of the app #2 into the ready queue 532 of the CPU #1 to end the migration. The OS 521 notifies the memory controller 509 of the end of the migration. When receiving notification of the end of the migration, the memory controller 509 clears the value of the access count field 2206 in the access log 2200 related to the app #0.

Since in the first example, detailed description is given of the case where a response instruction is issued within a certain time from the CPU #0 to the memory controller 509, the description thereof will not again be given. Since details of the control procedure of the third example are similar to the details of the control procedure of the first example with the exception of the access tendency data differing, description thereof will be omitted.

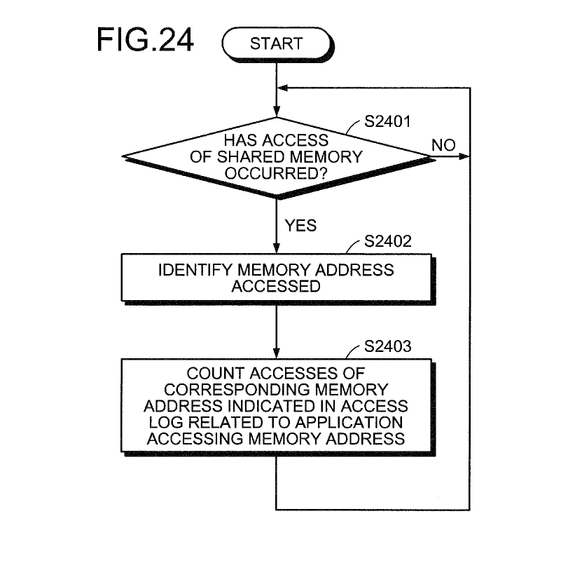

FIG. 24 is a flowchart of an updating procedure example for updating the access log related to the memory address. This updating procedure is performed for each OS. First, an OS determines whether an access of the shared memory 510 has occurred (step S2401) and upon determining that no access of the shared memory 510 has occurred (step S2401: NO), returns to step S2401.

Upon determining that access of the shared memory 510 has occurred (step S2401: YES), the OS identifies the memory address accessed (step S2402). A write command and a read command include the memory address accessed. The OS counts the accesses of the corresponding memory address indicated in the access log related to the application accessing the memory address (step S2403), and returns to step S2401.

In the fourth example, details described in the second example will be described using the memory address instead of the access count. First, when detecting a timer interruption, the memory controller 509 selects an unanalyzed application from among applications assigned to the CPUs. In this example, the app #0 assigned to the CPUs #0 is selected.

The memory controller 509 refers to the access log 2200 related to the app #0 and determines whether the rate of access of each of memory address is within the acceptable range. Since the rate of access of 0XFFF00000 to 0XFFFFFFFF is 0 [%] and the access rate at that timing interruption is 150 [%], the memory controller 509 determines the rate of access as not being within the predetermined range. The memory controller 509 lowers the ratio of access of the shared memory 510 by the app #0 to a value that is lower than that before the determination. The manner of lowering the access ratio is the same as the example described in the second example.

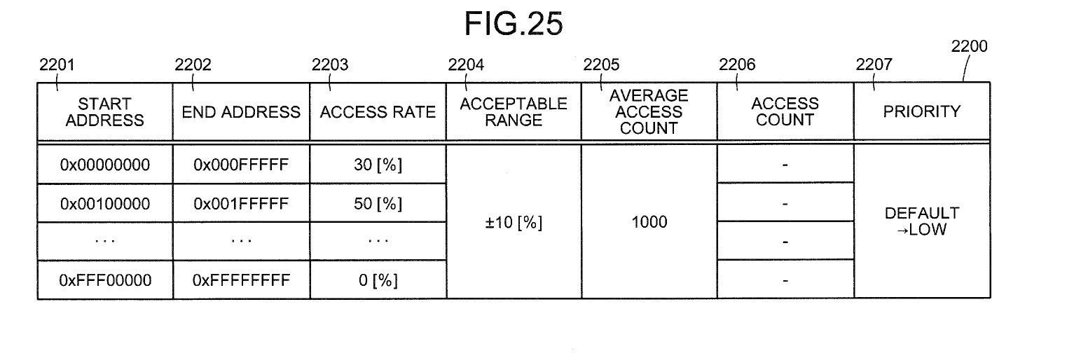

FIG. 25 is an explanatory view (1) of the access log of the fourth example. The memory controller 509 changes the value of the priority field 2207 in the access log 2200 of the app #0 from DEFAULT to LOW. The memory controller 509 then clears the value of the access count field 2206 in the access log related to the app #0. The memory controller 509 selects and analyzes an unanalyzed application from among the assigned applications, exclusive of the app #0.

When detecting the next timer interruption, the memory controller 509 selects an application from among unanalyzed applications assigned to the CPUs. Here, the app #0 assigned to the CPU #0 is selected.

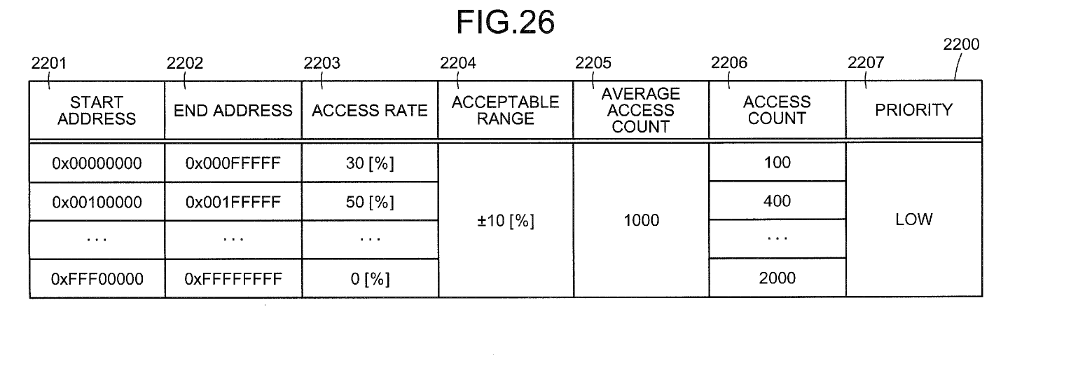

FIG. 26 is an explanatory view (2) of the access log of the fourth example. The memory controller 509 refers to the access log 2200 related to the app #0 to determine whether the rate of access of the addresses is within the predetermined acceptable range. Since the count of access of 0XFFF00000 to 0XFFFFFFFF is 2000 and the access rate is 200 [%], the access rate is determined as not being within the acceptable range.

The memory controller 509 then determines whether the access count of the app #0 continues to not be within the acceptable range. For example, the memory controller 509 checks whether the value of the priority field 2207 in the access log 2200 is LOW. Being LOW indicates that the access count is determined as not being within the acceptable range at the time of the previous timer interruption.

If the access count is not within the acceptable range consecutively at the previous timer interruption and at the current timer interruption, the app #0 or the CPU #0 to which the app #0 is assigned may have a high possibility of being in the error state. For example, if the access count is not within the acceptable range at the previous timer interruption but is within the acceptable range at the current timer interruption, the state of the app #0 or the CPU #0 may be unstable at the time of the previous timer interruption. However, the state of the app #0 or the CPU #0 is indicated to be normal at the time of the current timer interruption.

In this case, since the value of the priority field 2207 in the access log 2200 is already LOW, the state in which the access count is not within the acceptable range continues. The memory controller 509 identifies the CPU to which the app #0 is assigned and sends a signal to the CPU to determine whether a response from the CPU is received within a given time. In this example, the CPU #0 is the CPU to which the app #0 is assigned and thus, the memory controller 509 sends a response signal to the CPU #0.

If the memory controller 509 receives a response signal from the CPU #0 within a certain time after the sending of the response signal, the memory controller 509 identifies a CPU having the minimum load among the CPUs #1 and #2 of the multi-core processor, exclusive of the CPU #0. For example, the memory controller 509 calculates for each of the CPUs, a total run time of applications assigned to the CPU and regards the CPU having the lowest total value as being the minimum-load CPU. Since the total run time of applications assigned to the CPUs #1 and #2 are respectively 200 [μs] and 1 [ms], the CPU #1 is identified as being the minimum-load CPU. Although in this example the memory controller 509 is described to identify the minimum-load CPU, the CPU #0 may identify the minimum-load CPU.

The memory controller 509 sends to the CPU #0, an interrupt signal that delivers an execution right to the OS 521 and notifies the CPU #0 of a migration instruction to migrate from the CPU #0 to the CPU #1, all apps among the assigned applications, exclusive of the app #0. In this example, the app #2 is subject to migration.

When receiving the migration instruction, the OS 521 causes execution data of the app #2 stored in the primary cache 501 to migrate from the primary cache 501 to the primary cache 502, using the snoop circuit 504. The OS 521 embeds a pointer of the context information of the app #2 into the ready queue 532 to thereby end the migration of the app #2. The OS 521 notifies the memory controller 509 of the end of the migration.

Upon receiving notification of the end of the migration, the memory controller 509 performs software resetting with respect to the CPU #0. The memory controller 509 then clears the value of the access count field 2206 in the access log 2200 related to the app #0 and changes the value of the priority field 2207 from LOW to DEFAULT.

Since details of the control procedure of the fourth example are similar to the details of the control procedure of the second example with the exception of the access tendency data differing, description thereof will be omitted.

According to the processor processing method and the control device, as described in the first and the third examples, if the tendency data concerning memory access by an given application running on a given CPU is not within the acceptable range, another application already assigned to the given CPU is caused to migrate to another CPU. That is, if the memory access tendency of an app running on the given CPU differs from the case of normal operation of the given application, the given application or the given CPU may have an error. Thus, by causing another application already assigned to the given CPU to migrate to another CPU, the error can be prevented from affecting another application.

By notifying the given CPU of an migration instruction for a migration process to migrate from the given CPU to another CPU, another application assigned to the given CPU, the given CPU is caused to execute the migration process. This enables another assigned application to be evacuated to another CPU, preventing the error from affecting the other application.

By notifying the other CPU of an migration instruction for a migration process to migrate from the given CPU to the other CPU, another application assigned to the given CPU, the other CPU is caused to execute the migration process. This enables another assigned application to be evacuated to the other CPU, preventing the error from affecting the other application.

If no response is received as a result of the check of response from the given CPU, the other CPU is notified of a migration instruction for a migration process to migrate from the given CPU to the other CPU, another application assigned to the given CPU, thereby causing the other CPU to execute the migration process. Accordingly, when another application is not run due to the error state of the given CPU, the other application can be run as usual by causing the other application to migrate thereto and run the other application.

Through software resetting of the given CPU after the migration of an application to the other CPU, the area used in the shared memory by the given CPU is reset so that the given CPU can be recovered from the error state.

Through hardware resetting of the given CPU after the migration of an application to the other CPU, the area in the shared memory used by the given CPU and the value of the register in the given CPU are reset so that the given CPU can be recovered from the error state.

As described in the second and fourth examples, whether the tendency data concerning the memory access by the given application running on the given CPU is within the acceptable range is determined. If the tendency data concerning access of the shared memory is not within the acceptable range, the memory access tendency of the running app differs from that during normal operation. In other words, the app or the core to which the app is assigned may have an error. Thus, by lowering the priority of access of the shared memory by the given application to value that is lower than that before the determination, the access of the memory by applications running on another CPU can be prevented from being affected.

After the elapse of a certain time from the determination, whether the tendency data concerning the memory access by the given application running on the given CPU is within the acceptable range is determined. That is, over plural times, whether the tendency data concerning the memory access by the given application running on the given CPU is within the acceptable range is determined. If the tendency data concerning the memory access by the given application running on the given CPU continues to not be within the acceptable range, the possibility of the error state becomes high and thus, another application assigned to the given CPU is caused to migrate to another CPU. This can prevent the error from affecting another application assigned to the given CPU.

If it is determined in the past that the tendency data concerning access of the shared memory is not within the acceptable range and if it is determined this time that the tendency data concerning access to the shared memory is within the acceptable range, the priority of the access is raised. If the tendency data concerning the memory access by the given application running on the given CPU continues to not be within the acceptable range, there is a possibility that no error state is occurring. This can improve the accuracy of determination of whether the error state is occurring.

By resetting the given CPU after the migration of another application to the other CPU, the given CPU can be recovered from the error state.

Through software resetting of the given CPU after the migration of an application to the other CPU, the area used in the shared memory by the given CPU is reset so that the given CPU can be recovered from the error state.

Through hardware resetting of the given CPU after the migration of an application to the other CPU, the area in the shared memory used by the given CPU and the value of the register in the given CPU are reset so that the given CPU can be recovered from the error state.

The tendency data concerning access of the shared memory by the given application is information concerning the access count. An increase in the access count as compared to during normal operation may mean an abnormal state and prevent access of the shared memory by another CPU. A reduction in the access count as compared to during normal operation, i.e., no access of the shared memory for a certain time may mean that the given application is in the hang-up state. This enables easy detection of the hand-up state and a state in which access of the shared memory by another CPU is prevented. Drops in the overall operation performance of the multi-core processor system can be prevented to, thereby, improve reliability.

The tendency data concerning access of the shared memory by the given application is information concerning the memory address accessed. For example, if a memory address different from the memory address during normal operation is accessed, the given application may be executing an errant command. This enables the error state to be easily detected, preventing drops in the overall operation performance of the multi-core processor system and thereby, improving reliability.

This processor processing method can be implemented by the memory controller 509 having the request control unit 801 to the I/O control unit 806.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor processing method that is executed by a memory controller, the processor processing method comprising:
judging, based on a log of access of a shared resource by a first application, whether the first application running on a first processor operates normally; and
instructing a second processor to run a second application other than the first application in case of judging the first application to not be operating normally.

2. The processor processing method according to claim 1, comprising:
lowering a priority of the access of the shared resource by the first application upon the first application being determined to not be operating normally.

3. The processor processing method according to claim 1, wherein
the instructing includes instructing the second processor to run the second application upon the first application being repeatedly determined to not be operating normally.

4. The processor processing method according to claim 1, comprising:
raising a priority of the access of the shared resource by the first application upon the first application being determined to be operating normally after being determined to not be operating normally.

5. The processor processing method according to claim 1, comprising:
supplying a signal to the first processor upon the first application being determined to not be operating normally.

6. The processor processing method according to claim 5, wherein
the first processor delivers the second application to the second processor when the first processor sends a response to the signal.

7. The processor processing method according to claim 5, wherein
the second processor causes the first processor to deliver the second application to the second processor when the first processor does not send a response to the signal.

8. A processor processing method executed by a memory controller, the processor processing method comprising:
judging, based on a log of access of a shared resource by a first application, whether the first application running on a first processor operates normally; and
lowering a priority of the access of the shared resource by the first application in case of judging the first application to not be operating normally.

9. A processor system comprising:
a plurality of processors; and
a control apparatus that controls access of a shared resource that is shared by the processors, wherein
the control apparatus is configured to:
judge, based on a log of the access of the shared resource by a first application, whether the first application running on a first processor operates normally; and
instruct a second processor to run a second application other than the first application in case of judging the first application to not be operating normally.

10. The processor system according to claim 9, wherein
the control apparatus lowers a priority of the access of the shared resource by the first application upon determining that the first application is not operating normally.

11. The processor processing method according to claim 9, wherein
the control apparatus raises a priority of the access of the shared resource by the first application, upon determining that the first application is operating normally after having determined that the first application is not operating normally.
